(19) United States
(12) Patent Application Publication
(10) Pub. No.: US 2003/0116753 A1
(43) Pub. Date: Jun. 26, 2003

(54) High surface area carbon composites

(75) Inventors: Julian Norley, Chagrin Falls, OH (US); Robert Anderson Reynolds III, Bay Village, OH (US)

Correspondence Address: James R. Cartiglia, UCAR International Inc., Brandywine West, 1521 Concord Pike, Suite 301, Wilmington, DE, 19803, US

(73) Assignee: Graftech Inc., Lakewood, OH

(21) Appl. No.: 10/027,475

(22) Filed: Dec. 21, 2001

(51) Int. Cl. H01B 1/00

(52) U.S. Cl. 252/500

(57) ABSTRACT

Flexible graphite sheets having enhanced surface area prepared from materials comprising expanded graphite particles and activated carbon particles on phenol resin. The sheets with enhanced surface area are useful in the formation of articles adapted for use in supercapacitors.

### TECHNICAL FIELD

This invention relates to flexible graphite materials having increased surface area. These materials are useful in applications such as supercapacitors, battery electrodes, fuel cell diffusion layers and catalyst carriers.

### BACKGROUND OF THE INVENTION

Carbon electrodes are being used in the emerging market of supercapacitors which are energy storage/pulse power devices used, for example, in memory protection systems for consumer electronics (VCR's, clock radio, CD's), electric vehicles, and un-interruptible power systems (UPS).

Supercapacitors, sometimes also called ultracapacitors and double-layer capacitors, are capable of rapidly charging to store significant amounts of energy and then delivering the stored energy in bursts on demand. To be useful, they must, among other properties, have low internal resistance, store large amounts of charge and be physically strong per unit weight. There are, therefore, a large number of design parameters that must be considered in their construction. It would be desirable to have procedures for producing component parts that would address these concerns such that the final supercapacitor assembly could be more effective on a weight and/or cost basis.

Supercapacitors of the double-layer type generally include two porous electrodes, kept from electrical contact by a porous separator. Both the separator and the electrodes are immersed within an electrolyte solution. The electrolyte is free to flow through the separator, which is designed to prevent electrical contact between the electrodes and short-circuiting of the cell. Current collecting plates are in contact with the backs of active electrodes. Electrostatic energy is stored in polarized liquid layers, which form when a potential is applied across the two electrodes. A double layer of positive and negative charges is formed at the electrode-electrolyte interface.

Since capacitors store energy in the form of a separated electrical charge (the measurement of which is referred to as “charge separation”), the greater the area for storing charge, and the closer the separated charges, the greater the capacitance. A conventional capacitor gets its area from plates of a flat, conductive material. To achieve high capacitance, this material can be wound in great lengths, and can sometimes have a texture imprinted on it to increase its surface area. A conventional capacitor separates its charged plates with a dielectric material, sometimes a plastic or paper film, or a ceramic. These dielectrics can be made only as thin as the available films or applied materials.

A supercapacitor gets its area from a porous carbon-based electrode material. The porous structure of this material allows its surface area to be much greater than can be accomplished using flat or textured films and plates. A supercapacitor's charge separation is determined by the size of the ions in the electrolyte which are attracted to the charged electrode. This charge separation (less than 10 angstroms) is much smaller than can be accomplished using conventional dielectric materials. The combination of enormous surface area and extremely small charge separation gives the supercapacitor its superior capacitance relative to conventional capacitors.

The use of graphite electrodes in electrochemical capacitors with high power and energy density provides a number of advantages, but economics and operating efficiency are in need of improvement. Fabrication of double layer capacitors with carbon electrodes is known. See, for example, U.S. Pat. No. 6,094,788, to Farahmandhi, et al., U.S. Pat. No. 5,859,761, to Aoki, et al., U.S. Pat. No. 2,800,616, to Becker, and U.S. Pat. No. 3,648,126, to Boos, et al. The art has been utilizing graphite electrodes for capacitors of this type for some time and is still facing challenges in terms of material selection and processing.

To better understand the complexity of the above considerations, we present a brief description of graphite and the manner in which it is typically processed to form flexible sheet materials. Graphite, on a microscopic scale, is made up of layer planes of hexagonal arrays or networks of carbon atoms. These layer planes of hexagonally arranged carbon atoms are substantially flat and are oriented or ordered so as to be substantially parallel and equidistant to one another. The substantially-flat, parallel, equidistant sheets or layers of carbon atoms, usually referred to as graphene layers or basal planes, are linked or bonded together and groups thereof are arranged in crystallites. Highly-ordered graphite materials consist of crystallites of considerable size: the crystallites being highly aligned or oriented with respect to each other and having well ordered carbon layers. In other words, highly ordered graphites have a high degree of preferred crystallite orientation. It should be noted that graphites, by definition, possess anisotropic structures and thus exhibit or possess many characteristics that are highly directional, e.g., thermal and electrical conductivity and fluid diffusion. Sometimes this anisotropy is an advantage and at others it can lead to process or product limitations.

Briefly, graphites may be characterized as laminated structures of carbon, that is, structures consisting of superposed layers or laminae of carbon atoms joined together by weak van der Waals forces. In considering the graphite structure, two axes or directions are usually noted, to wit, the “c” axis or direction and the “a” axes or directions. For simplicity, the “c” axis or direction may be considered as the direction perpendicular to the carbon layers. The “a” axes or directions may be considered as the directions parallel to the carbon layers or the directions perpendicular to the “c” direction. The graphites suitable for manufacturing flexible graphite sheets possess a high degree of orientation.

As noted above, the bonding forces holding the parallel layers of carbon atoms together are only weak van der Waals forces. Graphites can be chemically treated so that the spacing between the superposed carbon layers or laminae can be appreciably opened up so as to provide a marked expansion in the direction perpendicular to the layers, that is, in the “c” direction, and thus form an expanded or intumesced graphite structure in which the laminar character of the carbon layers is substantially retained.

Graphite flake which has been chemically or thermally expanded and more particularly expanded so as to have a final thickness or “c” direction dimension which is as much as about 80 or more times the original “c” direction dimension, can be formed without the use of a binder into cohesive or integrated sheets of expanded graphite, e.g. webs, papers, strips, tapes, or the like (typically referred to as “flexible graphite”). The formation of graphite particles which have been expanded to have a final thickness or “c” dimension which is as much as about 80 times or more the original “c” direction dimension into integrated flexible sheets by compression, without the use of any binding material, is believed to be possible due to the mechanical interlocking, or cohesion, which is achieved between the voluminously expanded graphite particles.

In addition to flexibility, the sheet material, as noted above, has also been found to possess a high degree of anisotropy with respect to thermal and electrical conductivity and fluid diffusion, due to orientation of the expanded graphite particles substantially parallel to the opposed faces of the sheet resulting from very high compression, e.g. roll processing. Sheet material thus produced has excellent flexibility, good strength and a very high degree or orientation. There is a need for processing that more fully takes advantage of these properties.

Flexible graphite sheet material made as described above typically exhibits an appreciable degree of anisotropy due to the alignment of graphite particles parallel to the major opposed, parallel surfaces of the sheet, with the degree of anisotropy increasing upon roll pressing of the sheet material to increase orientation. In anisotropic sheet material, the thickness, i.e. the direction perpendicular to the opposed, parallel sheet surfaces comprises the “c” direction and the directions ranging along the length and width, i.e. along or parallel to the opposed, major surfaces comprises the “a” directions and the thermal, electrical and fluid diffusion properties of the sheet are very different, by orders of magnitude typically, for the “c” and “a” directions. It would be desirable to have a process that would permit increasing thermal and/or electrical conductivity when needed.

Graphite sheet is clearly attractive as a material for use in supercapacitors, because of its low cost, low electrical resistance and its availability in sheet form. For flexible graphite sheet to be used in a supercapacitor material, its surface area should preferably be increased, while its other attractive properties are not appreciably degraded.

### SUMMARY OF THE INVENTION

It is object of the invention to provide flexible graphite having a high surface area.

It is yet another object of the invention to provide a binding/carrying medium for activated carbon, which medium will not adversely impact the functionality of the activated carbon.

It is yet another object of the invention to provide a flexible graphite material exhibiting one or more of the following features: high power density (an ability to switch on at relatively high frequency), low electrical resistance, a low leakage current, a low cost compared to activated carbon cloth electrodes.

These and other objects are accomplished by the present invention, which provides a flexible material formed from a mass of expanded graphite to which activated carbon has been added prior to being rolled or pressed into, for example, flexible sheets, and/or which includes phenolic resin within the flexible graphite sheets.

### DETAILED DESCRIPTION OF THE INVENTION

This invention is based upon the finding that when high surface area activated carbon and/or phenolic resin is incorporated into flexible graphite sheets, the novel high surface area flexible sheets which result exhibit new and novel properties which particularly adapt such sheets for use in constructing supercapacitors.

Central to all of the embodiments of the invention is the provision of a flexible graphite sheet material (also termed “foil”) to which has been added a substance chosen to increase surface area.

Before describing the manner in which the invention improves current materials, a brief description of graphite and its formation into flexible sheets, which will become the primary substrate for forming the products of the invention, is in order.

Preparation of Flexible Graphite Foil

Graphite is a crystalline form of carbon comprising atoms covalently bonded in flat layered planes with weaker bonds between the planes. By treating particles of graphite, such as natural graphite flake, with an intercalant of, e.g. a solution of sulfuric and nitric acid, the crystal structure of the graphite reacts to form a compound of graphite and the intercalant. The treated particles of graphite are hereafter referred to as “particles of intercalated graphite.” Upon exposure to high temperature, the intercalant within the graphite decomposes and volatilizes, causing the particles of intercalated graphite to expand in dimension as much as about 80 or more times its original volume in an accordion-like fashion in the “c” direction, i.e. in the direction perpendicular to the crystalline planes of the graphite. The exfoliated graphite particles are vermiform in appearance, and are therefore commonly referred to as worms, and are sometimes referred to herein as “particles of expanded graphite”. The worms may be compressed together into flexible sheets that, unlike the original graphite flakes, can be formed and cut into various shapes and provided with small transverse openings by deforming mechanical impact.

Graphite starting materials suitable for use in the present invention include highly graphitic carbonaceous materials capable of intercalating organic and inorganic acids as well as halogens and then expanding when exposed to heat. These highly graphitic carbonaceous materials most preferably have a degree of graphitization of about 1.0. As used in this disclosure, the term “degree of graphitization” refers to the value g according to the formula:

$$g = \frac{3.45 - d ( 002 )}{0.095}$$

where d(002) is the spacing between the graphitic layers of the carbons in the crystal structure measured in Angstrom units. The spacing d between graphite layers is measured by standard X-ray diffraction techniques. The positions of diffraction peaks corresponding to the (002), (004) and (006) Miller Indices are measured, and standard least-squares techniques are employed to derive spacing which minimizes the total error for all of these peaks. Examples of highly graphitic carbonaceous materials include natural graphites from various sources, as well as other carbonaceous materials such as carbons prepared by chemical vapor deposition and the like. Natural graphite is most preferred.

The graphite starting materials used in the present invention may contain non-carbon components so long as the crystal structure of the starting materials maintains the required degree of graphitization and they are capable of exfoliation. Generally, any carbon-containing material, the crystal structure of which possesses the required degree of graphitization and which can be intercalated and exfoliated, is suitable for use with the present invention. Such graphite preferably has an ash content of less than twenty weight percent. More preferably, the graphite employed for the present invention will have a purity of at least about 94%. In the most preferred embodiment, the graphite employed will have a purity of at least about 98%.

A common method for manufacturing graphite sheet is described by Shane et al. in U.S. Pat. No. 3,404,061, the disclosure of which is incorporated herein by reference. In the typical practice of the Shane et al. method, natural graphite flakes are intercalated by dispersing the flakes in a solution containing e.g., a mixture of nitric and sulfuric acid, advantageously at a level of about 20 to about 300 parts by weight of intercalant solution per 100 parts by weight of graphite flakes (pph). The intercalation solution contains oxidizing and other intercalating agents known in the art. Examples include those containing oxidizing agents and oxidizing mixtures, such as solutions containing nitric acid, potassium chlorate, chromic acid, potassium permanganate, potassium chromate, potassium dichromate, perchloric acid, and the like, or mixtures, such as for example, concentrated nitric acid and chlorate, chromic acid and phosphoric acid, sulfuric acid and nitric acid, or mixtures of a strong organic acid, e.g. trifluoroacetic acid, and a strong oxidizing agent soluble in the organic acid. Alternatively, an electric potential can be used to bring about oxidation of the graphite. Chemical species that can be introduced into the graphite crystal using electrolytic oxidation include sulfuric acid as well as other acids.

In a preferred embodiment, the intercalating agent is a solution of a mixture of sulfuric acid, or sulfuric acid and phosphoric acid, and an oxidizing agent, i.e. nitric acid, perchloric acid, chromic acid, potassium permanganate, hydrogen peroxide, iodic or periodic acids, or the like. The intercalation solution may also contain metal halides such as ferric chloride, and ferric chloride mixed with sulfuric acid, or a halide, such as bromine, as a solution of bromine and sulfuric acid or bromine, in an organic solvent.

The quantity of intercalation solution may range from about 20 to about 150 pph and more typically about 50 to about 120 pph. After the flakes are intercalated, any excess solution is drained from the flakes and the flakes are water-washed. Alternatively, the quantity of the intercalation solution may be limited to between about 10 and about 50 pph, which permits the washing step to be eliminated as taught and described in U.S. Pat. No. 4,895,713, the disclosure of which is also herein incorporated by reference.

The particles of graphite flake treated with intercalation solution can optionally be contacted, e.g. by blending, with a reducing organic agent selected from alcohols, sugars, aldehydes and esters which are reactive with the surface film of oxidizing intercalating solution at temperatures in the range of 25° C. and 125° C. The organic reducing agent increases the expanded volume (also referred to as “worm volume”) upon exfoliation and is referred to as an expansion aid. Suitable specific organic agents include hexadecanol, octadecanol, 1-octanol, 2-octanol, decylalcohol, 1,10 decanediol, decylaldehyde, 1-propanol, 1,3 propanediol, ethyleneglycol, polypropylene glycol, dextrose, fructose, lactose, sucrose, potato starch, ethylene glycol monostearate, diethylene glycol dibenzoate, propylene glycol monostearate, glycerol monostearate, dimethyl oxylate, diethyl oxylate, methyl formate, ethyl formate, ascorbic acid and lignin-derived compounds, such as sodium lignosulfate. The amount of organic reducing agent is suitably from about 0.5 to 4% by weight of the particles of graphite flake.

Another class of expansion aid that can be added to the intercalating solution, or to the graphite flake prior to intercalation, and work synergistically with the above-described organic reducing agent are carboxylic acids. A carboxylic acid expansion aid in this context will advantageously be sufficiently soluble in the intercalation solution to achieve an improvement in expansion. More narrowly, organic materials of this type that contain carbon, hydrogen and oxygen, preferably exclusively, may be employed. A suitable carboxylic acid useful as the expansion aid can be selected from aromatic, aliphatic or cycloaliphatic, straight chain or branched chain, saturated and unsaturated monocarboxylic acids, dicarboxylic acids and polycarboxylic acids which have at least 1 carbon atom, and preferably up to about 15 carbon atoms, which is soluble in the intercalation solution in amounts effective to provide a measurable improvement of one or more aspects of exfoliation. Suitable organic solvents can be employed to improve solubility of an organic expansion aid in the intercalation solution.

Representative examples of saturated aliphatic carboxylic acids are acids such as those of the formula H(CH₂)ₙCOOH wherein n is a number of from 0 to about 5, including formic, acetic, propionic, butyric, pentanoic, hexanoic, and the like. Sulfuric acid, nitric acid and other known aqueous intercalants have the ability to decompose formic acid, ultimately to water and carbon dioxide. Because of this, formic acid and other sensitive expansion aids are advantageously contacted with the graphite flake prior to immersion of the flake in aqueous intercalant. Representative of dicarboxylic acids are aliphatic dicarboxylic acids having 2-12 carbon atoms, in particular oxalic acid, fumaric acid, malonic acid, maleic acid, succinic acid, glutaric acid, adipic acid, 1,5-pentanedicarboxylic acid, 1,6-hexanedicarboxylic acid, 1,10-decanedicarboxylic acid, cyclohexane-1,4-dicarboxylic acid and aromatic dicarboxylic acids such as phthalic acid or terephthalic acid. Representative of cycloaliphatic acids is cyclohexane carboxylic acid and of aromatic carboxylic acids are benzoic acid, naphthoic acid, anthranilic acid, p-aminobenzoic acid, o-, m- and p-tolyl acids, methoxy and ethoxybenzoic acids, acetoacetamidobenzoic acids and, acetamidobenzoic acids, phenylacetic acid and naphthoic acids.

The intercalation solution will be aqueous and will preferably contain an amount of carboxylic acid expansion aid of from about 0.2 to 10%, the amount being effective to enhance exfoliation. In the embodiment wherein formic acid is contacted with the graphite flake prior to immersing in the aqueous intercalation solution, it can be admixed with the graphite by suitable means, such as a V-blender, typically in an amount of from about 0.2% to about 10% by weight of the graphite flake.

After intercalating the graphite flake, and following the blending of the intercalant coated intercalated graphite flake with the organic reducing agent, the blend is exposed to temperatures in the range of 250 to 125° C. to promote reaction of the reducing agent and intercalant coating. The heating period is up to about 20 hours, with shorter heating periods, e.g., at least about 10 minutes, for higher temperatures in the above-noted range. Times of one-half hour or less, e.g., on the order of 10 to 25 minutes, can be employed at the higher temperatures.

The thus treated particles of graphite are sometimes referred to as “particles of intercalated graphite.” Upon exposure to high temperature, e.g. temperatures of at least about 160° C. and especially about 700° C. to 1000° C. and higher, the particles of intercalated graphite expand as much as about 80 to 1000 or more times their original volume in an accordion-like fashion in the c-direction, i.e. in the direction perpendicular to the crystalline planes of the constituent graphite particles. The expanded, i.e. exfoliated, graphite particles are vermiform in appearance, and are therefore commonly referred to as worms, and are sometimes referred herein as “particles of expanded graphite”. The worms may be compressed together into flexible sheets that, unlike the original graphite flakes, can be formed and cut into various shapes and provided with small transverse openings by deforming mechanical impact as hereinafter described.

Flexible graphite sheet and foil are coherent, with good handling strength, and are suitably compressed, e.g. by roll-pressing, to a thickness of about 0.075 mm to 3.75 mm and a typical density of about 0.1 to 1.4 grams per cubic centimeter (g/cc).

There are a variety of means contemplated by the invention for significantly enhancing the surface area of flexible graphite foils. Such methods include:

(1) the direct mixture of washed, acid treated graphite particles or flake with activated carbon, prior to introduction of the treated graphite into an exfoliation furnace, wherein the graphite is expanded as described above, or

(2) the direct addition of activated carbon particles to the top of a bed of expanded graphite which is already in a vermiform or worm state, the bed of expanded graphite having been prepared as described above. In such a process the activated carbon particles can be made to adhere to the worms of expanded graphite by optimally spraying or otherwise applying a small amount of a suitable adhesive, or even water, to the worms, prior to formation of the activated carbon/vermiform graphite mixture into flexible sheets, or

(3) the direct addition of activated carbon particles to vermiform graphite just prior to subjecting the vermiform graphite to compression, at which point conventionally a shaker table or vibrating belt may be spreading the vermiform graphite in preparation for compression by, e.g., calendering between pressure rolls, or

(4) distributing activated carbon particles directly onto vermiform graphite that has been compressed, but not to the final desired thickness, prior to compression to final thickness, or

(5) the activated carbon may be bonded to flexible graphite sheets by the use of a suitable binder, for example, a phenol or epoxy resin. In such a procedure, a conventional flexible graphite sheet may be perforated by impacting with a knurled tool to form multiple pockets capable of supporting activated carbon in an arrangement such that the activated carbon is accessible to an electrolyte. The flexible graphite so perforated is then saturated with a phenolic or epoxy resin, the resin dried and activated carbon particles deposited into the perforation. Upon curing the activated carbon is bound to the flexible graphite sheet. The sheet provides high conductivity for charging and discharging and the contained activated carbon provides the high surface area required for high capacitance.

(6) the introduction of phenolic resin in powder, fiber or flake form into the worm hopper or worm bed wherein the resin can be mixed homogeneously with the worms, travel with them and be formed in a continuous manner into a foil, which can then be heated to cure and consolidate the resin with the flexible graphite foil, resulting in a foil with enhanced porosity and having increased surface area.

The amount of activated carbon material added to the flexible graphite sheet can vary by application, but should preferably be at least about 10% by weight, more preferably at least about 20% by weight. Carbon loadings significantly higher than 40% by weight may degrade the coherence of the sheet.

The following example is presented to further illustrate and explain the invention and are not intended to be limiting in any regard. Unless otherwise indicated, all part and percentages are by weight.

### EXAMPLE

Activated carbon containing flexible graphite sheets was manufactured by blending activated carbon with water-wetted expanded graphite worm and then calendering the subsequent matt into a thin, high density sheet (approximately 0.007″, 0.99 g/cm³). The activated carbon had a surface area of 1400-1800 m²/g (Westvaco Nuchar SA20 powdered activated carbon.) Sheets were prepared having a 25% and 35% activated carbon loading.

Table 1 contains measurements of various parameters for the flexible sheets prepared as described above and compares those parameters to two standard Grafoil flexible graphite sheets which serve as controls. Table 1 provides data for sheets which incorporate activated carbon of several different particle sizes and mass fractions of activated carbon.

TABLE 1
Comparison of Control Flexible Graphite Foils with Graphite Foils Containing Activated Carbon

| Mesh | | | | | | | | | |
|---|---|---|---|---|---|---|---|---|---|
| BET | | | | | | | | Resistivity | |
| Size | Estimated | Mass | Thickness | Thickness | Density | Density | Resistivity | Through | Tensile |
| SA | Particle Size | Fraction | Sheet | sample | Sheet | sample | in-Plane | Thickness | Strength |
| m2/g | microns | Act. Carbon | mm | mm | g/cm3 | g/cm3 | micro-ohm-m | micro-ohm-m | psi |
| Grafoil-1 | n/a | 0 | | 0.14 | | 1.56 | 5 | 17262 | |
| 20 | | | | | | | | | |
| Grafoil-2 | n/a | 0 | | | | 1.22 | 6 | 15184 | 843 |
| As-Received | 71 | 25 | 0.19 | 0.18 | 0.99 | 1.05 | 15 | 6446 | n/a |
| 269 + | 165 | 25 | 0.19 | 0.17 | 1.01 | 1.15 | 11 | 10439 | 369 |
| 100 | | | | | | | | | |
| 289 | 113 | 25 | 0.22 | 0.19 | 0.93 | 1.05 | 12 | 11227 | 292 |
| −100/+200 | | | | | | | | | |
| 305 | 60 | 25 | 0.21 | 0.21 | 0.97 | 0.95 | 15 | 10645 | 213 |
| −200/+325 | | | | | | | | | |
| 327 − | 42 | 25 | 0.19 | 0.17 | 0.99 | 1.1 | 15 | 13393 | 169 |
| 325 | | | | | | | | | |
| 306 − | 42 | 35 | 0.25 | 0.24 | 0.79 | 0.82 | 32 | 7926 | 45 |
| 325 | | | | | | | | | |
| 424 | | | | | | | | | |

The unmodified control flexible graphite sheets in Table 1 have a surface area of 20 m²/g, which is within the range expected for such foils. Table 1 demonstrates that for those foils that contain activated carbon particles BET surface area is not appreciably affected by particle size variation (range 269-327 g/cm2), and that BET increases proportionately with the mass fraction of activated carbon. However, the tensile strength of the sheet is significantly impacted by particle size—the finer the particle, the lower the strength. The combination of fine particle size and high mass fraction yields low tensile strength.

Table 2 sets forth various electric parameters measured for the two samples of flexible graphite sheet having activated carbon loadings of 25% and 35%, in a 38% aqueous sulfuric acid electrolyte. Table 2 demonstrates high levels of capacitance (>1F) with the capacitance being approximately proportional to the amount of activated carbon in the sheet material. The leakage current values are in a good, very acceptable range.

Table 3 sets for various electrical parameters measured using an organic electrolyte (0.8M TEATFB₄ in PC and DMC) for flexible graphitic sheet having activated carbon loadings of 25% and 35%. A comparison of Table 2 with Table 3 demonstrates lower capacitance values for the organic electrolyte. This is as expected, for it is consistent with the larger ion size of the organic electrolyte. Values of ESR are higher for the organic versus the aqueous electrolyte, which is consistent with the differences in ionic conductivity between the two electrolytes.

TABLE 2
Electrical Characteristics in 38% Aqueous Sulfuric Acid Electrolyte of Flexible Graphite Foils Containing
25% and 35% Activated Carbon

| % | Thickness | | | | Electrode | | | | | | Specific | Volumetric |
|---|---|---|---|---|---|---|---|---|---|---|---|---|
| Leakage | Current (microamps) | | | Density BET | Surface Mass | | | Capacit- | Capacit- | Specific | Capacitance | Capacitance |
| Activated | | 0.75 V | | Equil. at 1 V | Area | ESR | Charging | itance | itance | Capacitance | (electrode) | (activated) |
| Carbon | 0.5 V | inches | 1.0 V | g/cm3 | m2/g | g | ohms | Farads | F/m2 | F/g | F/g | F/cm3 |

| | | | | | | | | | | |
|---|---|---|---|---|---|---|---|---|---|---|
| 25 | 0.008 | 0.95 | 299 | 0.051 | 0.13 | 1.0 | 0.13 | 39.2 | 157 | 36 |

| | | | |
|---|---|---|---|
| 12 | 32 | 150 | 9.3 |

| | | | | | | | | | | |
|---|---|---|---|---|---|---|---|---|---|---|
| 35 | 0.010 | 0.81 | 424 | 0.055 | 0.14 | 1.4 | 0.12 | 50.9 | 145 | 40 |

| | | | |
|---|---|---|---|
| 18 | 50 | 130 | 15 |

| | | | |
|---|---|---|---|
| Typical | 1000 | 250 | 250 |
| Material | | | |

TABLE 3
Electrical Characteristics in an Organic Electrolyte (0.8 M TEATFB₄ in PC and DMC of Flexible Graphite Foils Containing
25% and 35% Activated Carbon

| % | Thickness | | | | Electrode | | | Capacit- | | | Specific | Volumetric |
|---|---|---|---|---|---|---|---|---|---|---|---|---|
| Leakage | Current (microamps) | | | Density BET | Surface Mass | | | ance | | Specific | Capacitance | Capacitance |
| Activated | | 1.5 V | | Equil. at 1 V | Area | ESR | Charging | 2 V | ance | Capacitance | (electrode) | (activated) |
| Carbon | 1.0 V | inches | 2.0 V | g/cm3 | m2/g | g | ohms | Farads | F/m2 | F/g | F/g | F/cm3 |

| | | | | | | | | | | |
|---|---|---|---|---|---|---|---|---|---|---|
| 25 | 0.008 | 0.95 | 299 | 0.054 | 2.3 | 0.16 | 0.02 | 5.9 | 24 | 5.4 |

| | | |
|---|---|---|
| 9.1 | 22 | 47 |

| | | | | | | | | | | |
|---|---|---|---|---|---|---|---|---|---|---|
| 35 | 0.010 | 0.77 | 424 | 0.050 | 2.1 | 0.28 | 0.03 | 11.2 | 32 | 7.9 |

| | | |
|---|---|---|
| 26 | 53 | 100 |

| | | | |
|---|---|---|---|
| Typical | 1000 | 250 | 250 |
| Material | | | |

The major negative trait exhibit by the foils that were the subject of Tables 2 and 3 was that the foils were slow to switch-on. The devices described in Tables 2 and 3 did not switch on until <1 Hz, whereas it would have been desirable to turn on at a higher frequency (10 Hz) to permit more rapid capacitor charging at the higher power density. The low power density of these devices is ascribed to the choice of activated carbon selected for incorporation in the foils. Activated carbon with known supercapacitor properties would have provided improved, higher power densities.

The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

What is claimed is:

1. A high surface area carbon composite material comprising a mass of expanded graphite particles together with activated carbon particles.

2. A carbon composite material in sheet form produced by compressing a mixture comprising expanded graphite and activated carbon particles.

3. The carbon composite material of claim 2 wherein activated carbon particles comprise from about 10 to about 40 weight percent of the carbon composite material.

4. A high surface area carbon composite material comprising a sheet comprising expanded graphite and a cured phenolic resin to which is adhered particles of activated carbon.

5. A process for preparing a high surface area carbon composite material comprising forming said material from a mass of expanded graphite particles together with activated carbon particles.

6. The process of claim 5 wherein the mass of expanded graphite particles together with activated carbon particles is compressed to form a sheet of high surface area carbon composite material.

7. A process for preparing a high surface area carbon composite material comprising the following steps:
(1) providing a flexible graphite sheet;
(2) creating indentations in the graphite sheet by rolling the sheet with a knurling tool;
(3) depositing a resin in the indentations on the flexible graphite sheet;
(4) depositing activated carbon particles onto the resin in the indentations on the flexible graphite sheet;
(5) curing the sheet with the resin and activated carbon particles thereon such that the activated carbon particles are bound to the resin.
